(19) United States
(12) Patent Application Publication
(10) Pub. No.: US 2006/0102053 A1
(43) Pub. Date: May 18, 2006

(54) Powdered material, method of manufacturing it, raw compact of the powdered material and device for the powdered material

(76) Inventors: Hakan Engqvist, Knivsta (SE); Leif Hermansson, Lanna (SE)

Correspondence Address: YOUNG & THOMPSON, 745 SOUTH 23RD STREET, 2ND FLOOR, ARLINGTON, VA, 22202, US

(21) Appl. No.: 10/518,080

(22) PCT Filed: Jun. 11, 2003
(86) PCT No.: PCT/SE03/00956

§ 371 Date: Sep. 29, 2005

(30) Foreign Application Priority Data
Jun. 20, 2002 (SE) 0201918-0

(51) Int. Cl. C04B 7/32

(52) U.S. Cl. 106/692

(57) ABSTRACT

A powdered material, the binder phase of which consisting of a cement-based system that has the capacity following saturation with a liquid reacting with the binder phase to hydrate to a chemically bonded ceramic material. According to the invention, the powdered material exists in the form of granules of powder particles, which granules exhibit a degree of compaction above 55% and a mean size of 30-250 μm. The invention also relates to a raw compact of the powdered material and a method in connection with the manufacturing of a ceramic material from a powdered material. The invention also relates to a device for the powdered material.

### TECHNICAL FIELD

The present invention relates to a powdered material, the binder phase of which consisting of a cement-based system that has the capacity following saturation with a liquid reacting with the binder phase to hydrate to a chemically bonded ceramic material. The invention also relates to a raw compact of the powdered material and a method in connection with the manufacturing of a ceramic material from a powdered material. In addition, the invention relates to a device for storing the powdered material and for mixing it with the liquid that reacts with the binder phase.

### STATE OF THE ART AND PROBLEM

The present invention relates to binding agent systems of the hydrating cement system type, in particular cement-based systems that comprise chemically bonded ceramics in the group that consists of aluminates, silicates, phosphates, sulphates and combinations thereof, preferably having cations in the group that consists of Ca, Sr and Ba. The invention has been developed in particular for biomaterials with applications within dental and orthopaedic areas, but is also suitable for other application such as cement-based systems for constructional purposes etc.

In such cement-based systems, the strength depends inter alia on the degree of compaction of the powder particles in the system. Simply put—the higher the degree of compaction, the greater the potential that a high strength can be reached. This principle has been used in the manufacturing of raw compacts from a powdered material that has the capacity following saturation with a liquid reacting with the binder phase to hydrate to a chemically bonded ceramic material. See e.g. SE 463,493, WO 00/21489 and WO 01/76535. One problem however is that the material loses in workability when the raw compact has been compacted directly from a loose powdered material, to a high degree of compaction. In the dental filling material application, this is expressed as the raw compact, after having been brought to absorb a small amount of liquid that is required for the hydration and when being worked in the location of a tooth cavity, “spattering” to a material that may be experienced by the dentist as dry and having a poor workability, as he/she applies a pressure on it with a moulding tool.

One way of achieving a better workability of the cement-based system, is not to shape it as a raw compact but instead to suspend the loose powdered material directly in the liquid reacting with the binder phase and after optional initial draining and compacting to perform a final draining and compacting directly in a cavity, e.g. a tooth cavity. See SE 502 987 and WO 01/76534 e.g. Here, the problem is that it is not possible to reach any higher degrees of compaction when compacting directly in a tooth cavity, which has an injurious effect on the strength of the ceramic material.

Especially in connection with dental filling materials, a desire also exists that the finished ceramic material should exhibit translucency as well as radio opacity (X-ray contrast). Natural tooth, especially the enamel, transmits light. The manner in which the light is diffused through the tooth is described as translucent, which is to be differentiated from transparent. A definition of a translucent material reads: “A material that reflects, transmits and absorbs light. Objects cannot be seen clearly through the material when the material is placed between the object and the observer” [1]. One method of measuring translucence is to determine the ratio between the quantity of reflected light with a white background and with a black background (ISO 9917). A material is described as translucent if it has an opacity of between 35 and 90%, as opaque above 90% and transparent below 35%. Natural dentine has an opacity of approx. 70%, while natural enamel has an opacity of around 35%. The ability of a dental filling material to imitate the appearance of the natural tooth depends to a large extent on the material being translucent. It is difficultly combined goals to reach translucency and radio opacity at the same time, since the X-ray contrast agents that are common today, ZrO₂ and SnO₂ e.g., disturb the translucency. In orthopaedic applications such as bone filling in damaged bone or at bone loss e.g., compositions based on the invention and having improved strength and X-ray contrast are essential.

### ACCOUNT OF THE INVENTION

The present invention aims at solving the problems mentioned above and thereby to offer a powdered material, the binder phase of which consisting of a cement-based system that has the capacity following saturation with a liquid reacting with the binder phase to hydrate to a chemically bonded ceramic material, which powdered material exhibits a high degree of compaction as well as a good workability. Yet another object of the invention is to provide such a material that also exhibits translucency as well as radio opacity. In addition, the invention aims at providing a device for storing the powdered material and for mixing it with the liquid that reacts with the binder phase.

These and other objects are attained by the powdered material according to the invention, the method and the device, such as presented in the claims.

According to the invention, the powdered material exists in the form of granules of powder particles, which granules exhibit a degree of compaction above 55% and a mean size of 30-250 μm. By using such very highly compacted small granules, the shaping of the material can take place in a subsequent step, without any remaining workability limitations of highly compacted bodies. A facilitated shaping in such a subsequent step, such as kneading, extrusion, tablet throwing, ultrasound etc., can be made while retaining a mobility in the system that has a high final degree of compaction, exceeding 55%, preferably exceeding 60%, even more preferred exceeding 65% and most preferred exceeding 70%.

The inventive principle is based on the fact that a small granule—after granulation of a pre-pressed, highly compacted body—contains several tenths of millions of contact points between particles in the same, which particles are in the micrometer magnitude. When these small granules are pressed together to form new bodies, new contact points arise, which new contact points are not of the same high degree of compaction. The lower degree of compaction in these new contact points results in an improved workability, while the total degree of compaction is only marginally lowered by the lower degree of compaction in the new contact points. This is due to the new contact points only constituting a very slight proportion of the total amount of contact points. Even if for example a thousand new contact points are formed, these contact surfaces will be less than per mile of the total contact surfaces, i.e. they have a very slight influence on the end density, which will be determined by the higher degree of compaction of the granules according to the present invention. Moreover, the contact zones between individual, packed granules will hardly be distinguishable from the other contact points, as the general hardening mechanism for systems according to the invention comprises dissolution of solid material by reaction with water, which leads to the formation of ions, a saturated solution and hydrate deposition.

In a system in which the cement hydrates due to an added liquid, the new contact points will furthermore be filled by hardened phases, which means that the homogeneity increases after the hydratisation/hardening. By the final degree of compaction being increased in that way, a more dense end product will be obtained, which leads to an increased strength, a possibility to lower the amount of radio-opaque agents and an easier achieved translucency, at the same time as the workability of the product is very good.

According to one aspect of the invention, the granules preferably exhibit a degree of compaction above 60%, even more preferred above 65% and most preferred above 70%. Preferably, the granules have a mean size of at least 30 μm, preferably at least 50 μm and even more preferred at least 70 μm, but 250 μm at the most, preferably 200 μm at the most and even more preferred 150 μm at the most, while the powder particles in the granules have a maximal particle size less than 20 μm, preferably less than 10 μm. It should hereby be noted that it is only a very slight proportion of the powder particles that constitute particles having the maximal particle size. The particle size is measured by laser diffraction. The highly compacted granules are manufactured by the powdered material being compacted to the specified degree of compaction, by cold isostatic pressing, tablet pressing of thin layers, hydro-pulse technique or explosion compacting e.g., where after the material compacted accordingly is granulated, for example crushed or torn to granules of the specified size.

According to another aspect of the invention, the cement-based systems comprises chemically bonded ceramics in the group that consists of aluminates, silicates, phosphates, sulphates and combinations thereof, preferably having cations in the group that consists of Ca, Sr and Ba. For dental filling materials, calcium aluminate cements are most preferred, the binder phase suitably having a composition somewhere between the phases 3CaO•Al₂O₃ and CaO•2Al₂O₃, suitably about 12CaO•7Al₂O₃ (optionally in glass phase). The calcium aluminate cement may also comprise one or more expansion compensating additives adapted to give the ceramic material dimensionally stable long-term attributes, as is described in WO 00/21489. In that case, one or more other cement binder phases to a total amount of less than 30% by volume is e.g. used, preferably 1-20% by volume and even more preferred 1-10% by volume. Admixtures of ordinary Portland cement (OPC cement) or fine crystalline silica are used advantageously. Furthermore, it is desirable for the ceramic material to have a hardness of at least 50 HV in the hydrated state, preferably at least 100 HV and even more preferredly 120-200 HV.

According to another aspect of the invention, the ceramic material has a translucence corresponding to 35-90%, preferably 40-85% and even more preferred 50-80% opacity in the hydrated state. It is preferred that the granules comprise an additive that is adapted to give radio-opacity to the ceramic material, while at the same time retaining or increasing the translucency of the ceramic material.

According to yet another aspect of the invention, the granules may therefore in addition to the binder phase comprise up to 50%, preferably 10-40% and even more preferred 20-35% by volume of one or more additives that preferably exhibit a refractive index in visible light that deviates 15% at the most, preferably 10% at the most and even more preferred 5% at the most from the refractive index of the hydrated binder phase. The similarity in refractive index between the binder phase and the additive enables translucency to be achieved. It is preferred that the additive consists of glass particles, preferably particles of silicate glass, said additive preferably containing an atom type with a density above 5 g/cm³, i.e. heavy metals from V and upwards in the periodic system, preferably Ba, Sr, Zr, La, Eu, Ta and/or Zn. One advantage of using an additive that contains barium and/or strontium is that since barium and strontium are in the same atomic group as calcium, barium and/or strontium can become part of the binder phase and replace calcium at certain points. When using glass having heavy atoms, translucency and radio-opacity can be achieved at the same time. Examples of additive materials that satisfy one or more of the stated requirements are: silicate glass, barium aluminium borosilicate glass, barium aluminium fluorosilicate glass, barium sulphate, barium fluoride, zirconium-zinc-strontium-borosilicate glass, apatite, fluorapatite and similar materials. In these materials barium can be exchanged for strontium and the materials can also contain fluoride.

It is also conceivable that said additives comprise a glass phase that contributes to translucency and that exhibits the capacity following saturation with a liquid reacting with the binder phase to hydrate to a chemically bonded ceramic material. Accordingly, the additive is reactive. A major advantage is that if the additive is built up from the same elements as the binder phase of the powdered material, they will have the same or essentially the same refractive index, at all wave lengths. Preferably, said additive in glass phase comprises calcium aluminate in glass phase, suitably having a composition somewhere between the phases 3CaO•Al₂O₃ and CaO•2Al₂O₃, suitably about 12CaO•7Al₂O₃, and preferably also a stabiliser adapted to dampen the reaction with the liquid. According to another embodiment, said additive in glass phase may comprise glass ionomer glass, i.e. glasses that are known for use in glass ionomer cement, preferably at content below 25% by volume, even more preferred below 15% by volume and even more preferred below 10% by volume.

As an alternative, or in combination, the additive may comprise bioactive or bioresorbable materials.

The additive material can also have any morphology or form, including: spheres, regular or irregular forms, whiskers, plates or the like. Particles of the additives should be smaller than 20 m, preferably smaller than 10 μm, even more preferred smaller than 5 μm. It is however also conceivable to manufacture the additive as glass fibres, in a manner known per se, to be used as additive according to the present invention.

According to another aspect of the invention, the inventive granules exist in a composition that comprises up to 50%, preferably 5-30% and even more preferred 10-20% by volume non pre-compacted powdered material, preferably of the same cement-based system as the powdered material in the granules, the rest or the main of the rest consisting of the granules. The non pre-compacted powdered material suitably exhibits a maximal particle size smaller than 20 μm, preferably smaller than 15 μm and even more preferred smaller than 10 μm. The non pre-compacted powdered material may additionally comprise up to 40%, preferably 5-30% and even more preferred 10-20% of a filler material, preferably a filler material in the form of plates, fibres or whiskers, that increases the strength and preferably exhibits a refractive index in visible light that deviates 15% at the most, preferably 10% at the most and even more preferred 5% at the most from the refractive index of the hydrated binder phase. The filler material can be constituted by any of the types of additives mentioned above, or may be purely strength increasing, but should preferably not deviate more in refractive index from the binder phase than what has been stated above. Examples of materials are silicate glasses, Al₂O₃ and CaO•SiO₂. Such filler materials that are purely strength increasing may of course also be used in the actual granules, preferably contents as described above.

The filler may moreover be added in order to act as a contributor for radio-opacity according to p. 4-5.

The powdered material according to the invention may also be formed as a raw compact, that has an average degree of compaction above 55%, preferably above 60%, even more preferred above 65% and most preferred above 70%. The raw compact suitably exhibits a largest outer dimension of 8 mm maximal and a smallest dimension of 0.3 mm minimal, its diameter or width being 1-8 mm, preferably 2-5 mm and its height being 0.3-5 mm, preferably 0.5-4 mm. Regarding other aspects of raw compacts, reference is made to WO 01/76535, the content of which being incorporated herein by reference.

According to another embodiment of the invention, the material can be suspended in a liquid that reacts with the binder phase, where after the resulting suspension is drained and compacted before the material is allowed to harden by reaction between the binder phase and any liquid remaining. The final compacting is suitably performed to a degree of compaction above 55%, preferably above 60%, even more preferred above 65% and most preferred above 70%. In addition to applications such as dental filling materials or orthopaedic compositions, applications within fields such as substrates/casting materials for electronics, micromechanics, optics and within biosensor techniques can be seen. The environmental aspects will also give the material a large field of use for yet another application, namely as an inorganic putty. Regarding other aspects concerning the method of suspension, reference is made to WO 01/76534, the content of which being incorporated herein by reference.

The material, preferably only in the form of granules including optional additives or possibly granules and non pre-compacted powder material according to the above, may, according to yet another embodiment, be mixed with a liquid that reacts with the binder phase, where after the resulting suspension is injected directly into a cavity that is to be filled. Suitably, the liquid comprises water and accelerator, dispersant and/or superplasticizer in order to achieve a suitable consistency of the suspension. The accelerator speeds up the hydrating reaction and is preferably composed of a salt of an alkali metal. Most preferably, a lithium salt is used, lithium chloride or lithium carbonate e.g. The superplasticizer is preferably composed of a lignosulphonate and/or citrate, EDTA and/or hydroxycarboxy containing compounds, PEG or substances with PEG-containing units. Also in the embodiment in which the suspension is drained and compacted, the accelerator, disperser and/or superplasticizer may of course be used, as well as in the embodiment in which the material is compacted to a raw compact, in which case the raw compact is brought to absorb the liquid when the ceramic material is to be produced.

### DESCRIPTION OF DRAWINGS

FIG. 1 is showing a device according to a first embodiment, for storing the powdered material and for mixing it with the liquid that reacts with the binder phase,

FIG. 2 is showing a device according to a second embodiment, for storing the powdered material and for mixing it with the liquid that reacts with the binder phase.

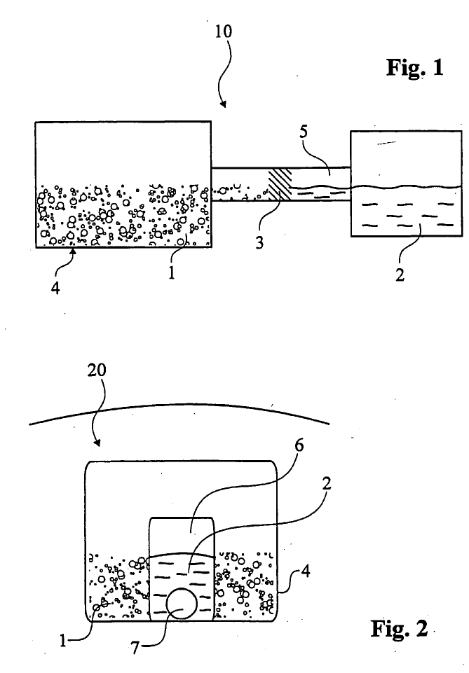

The device 10 in FIG. 1 is adapted to store granules according to the invention as well as the liquid that reacts with the binder phase. More particularly, a given amount of granules are held in a first chamber 1 and an amount of liquid that is adapted to the amount of granules and to the desired W/C ratio is held in a second chamber 2. The size, shape and filing degree of the chambers may vary, the filling degree usually being close to 100%. The chambers 1, 2 are connected to each other by a passage 5, which however is sealed by a seal 3 (a membrane e.g.) at storing. In the first chamber 1 there is preferably a lower pressure than in the second chamber 2. When a chemically bonded ceramic material is to be produced from the granules and the liquid, the seal 3 is broken and the liquid may flow from the second chamber 2 in to the first chamber 1, a possible pressure difference acting as a driving force, or by aid of a squeezing of the second chamber 2 and/or by aid of the gravitation. Accordingly, the supply of liquid takes place in a closed room.

The first chamber 1 at least is designed with walls 4 of a wall material that allows a mechanical processing of the granules/liquid through these walls 4. Suitably, the first chamber 1 is constituted by a flexible bag. Also the second chamber may be formed of the same material, the seal 3 being composed e.g. by a weld between the two chambers. The mechanical processing may for example be kneading, rolling, hand pressing, etc. The material is thereafter transferred to a system that is adapted for the applying.

FIG. 2 shows a second embodiment of a device according to the invention. In the device 20, the second chamber 2 is arranged inside the first chamber 1. The second chamber 2 has walls 6 in the form of or comprising a membrane, and holds a ball 7 (a plastic ball e.g.) in addition to the liquid. By shaking the entire device 20, the membrane is broken by the ball. Here too, a pressure difference preferably exists between chambers 1 and 2. Of course, the device may also be performed such that the first chamber with the granules is arranged inside the second chamber with the liquid. By the shaking and the pressure difference, a mixing of the liquid and the material will take place in any case, to form a paste. Thereafter, the paste is applied by a squirt, in a cavity that is to be filled by the material.

The device according to the invention is especially suitable for storage, distribution and preparation of the material when the material is composed of a dental or orthopaedic material, but can also be used in other applications.

### EXAMPLE 1

A trial series was performed in order to study the influence of the degree of compaction and the size of granules on the flexural strength of hydrated material.

Raw Materials

Calcium aluminate of the CA phase, fibres of wollastonite (CaO—SiO₂, CS), dental glass

The examples below describe
a) Flexural strength of hydrated material produced from powder.
b) Flexural strength of hydrated material produced from powder with fibres of wollastonit.
c) Flexural strength of hydrated material produced from granules of the size 50 μm and the degree of compaction 60%.
d) Flexural strength of hydrated material produced from granules of the size 150 μm and the degree of compaction 60%.
e) Flexural strength of hydrated material produced from granules of the size 50 μm and the degree of compaction 70%.
f) Flexural strength of hydrated material produced from granules of the size 150 μm and the degree of compaction 70%.
g) Flexural strength of hydrated material produced from granules of the size 100 μm and the degree of compaction 65%.

The composition and particle size of the powder mixtures in examples a-g, was: CA of a particle size of max 13 μm and a particle mean size of 3.5 μm and 15% by volume CS fibres having a length of max 10 μm and a diameter of 0.5 μm and 25% by volume of radio-opaque dental glass.

Powder for the examples a-g was mixed in a ball mill with inert silicon nitride mill balls with a filling degree of 35%. Isopropanol is used as the grinding liquid. After the solvent having been driven off, the powders for c and d were cold isostatically pressed at 204 MPa, to a degree of compaction of 60%. The powders for e and f at 307 MPa to a degree of compaction of 70% and g at 254 MPa to a degree of compaction of 65%. The pressed powders c-g were then crushed to granules of the respective sizes given above. The granule mixtures were then mixed with a liquid consisting of water, LiCl, dispersant and superplasticizer, to a water/cement ratio of 0.20 (weight ratio) in the form of a paste. Thereafter, the materials were kept moist at 37° C. for a week before measuring the flexural strength by a bi-axial geometry (ball on three balls) [1]. The results are shown in Table 1.

TABLE 1
Flexural strength for the different mixtures.

| Sample | Flexural strength (MPa) |
|---|---|
| A | 30 |
| B | 49 |
| C | 82 |
| D | 95 |
| E | 124 |
| F | 140 |
| G | 132 |

The results show that an increased strength in the material can be achieved by using granules as a starting material for production of the material, rather than a powder. An addition of fibres will also give a certain increase in strength.

### EXAMPLE 2

A trial series was performed in order to study the influence of the degree of compaction on the flexural strength of hydrated material.

Raw Materials

Calcium aluminate of the CA phase, fibres of wollastonite (CaO—SiO₂, CS), dental glass

The examples below describe
a) Flexural strength of hydrated material produced from powder.
b) Flexural strength of hydrated material produced from granules.

The composition and particle size of the powder mixtures in examples a-b, was: CA of a particle size of max 13 μm and a particle mean size of 3.5 μm and 15% by volume CS fibres having a length of max 10 μm and a diameter of 0.5 μm and 25% by volume of radio-opaque dental glass.

The powders for the examples was mixed in a ball mill with inert silicon nitride mill balls with a filling degree of 35%. Isopropanol is used as the grinding liquid. After the solvent having been driven off, the powder for b was cold isostatically pressed at 204 MPa, to a degree of compaction of 60%. The pressed powder b was then crushed to granules of 100 μm size. The granules were then mixed with a liquid consisting of water, LiCl, dispersant and superplasticizer, to a water/cement ratio of 0.19 (weight ratio) in the form of a paste. Cylindrical test bodies were formed from the paste. From the powder mixture a, raw compacts having a degree of compaction of 60% were produced by cold isostatic pressing, which raw compacts were wetted by a weak LiCl solution. Thereafter, the materials were kept moist at 37° C. for a week before measuring the flexural strength by a bi-axial geometry (ball on three balls) [1]. The results are shown in Table 1.

TABLE 1
Flexural strength for the different mixtures.

| Sample | Flexural strength (MPa) |
|---|---|
| A | 104 |
| B | 102 |

The results show that an equally high flexural strength can be achieved for the material by producing the raw compact from pre-compacted granules as by pressing to final shape.

The invention is not restricted to the embodiments detailed but can be varied within the scope of the claims.

References

1. Lemire, Burk, Color in dentistry, J. M. Ney Company (1975)

2. S. Ban, K. J. Anusavice, Influence on test method on failure stress of brittle dental materials, J Dent Res 69(12):1791-1799, December, 1990.

1. A powdered material, the binder phase of which consisting of a cement-based system that has the capacity following saturation with a liquid reacting with the binder phase to hydrate to a chemically bonded ceramic material, characterised in that it is in the form of granules of powder particles, which granules exhibit a degree of compaction above 55% and a mean size of 30-250 μm.

2. A powdered material according to claim 1, characterised in that said granules exhibit a degree of compaction above 60%, preferably above 65% and even more preferred above 70%.

3. A powdered material according to claim 1 characterised in that said granules exhibit a mean size of at least 50 μm, preferably at least 70 μm, but 200 pm at the most, preferably 150 μm at the most.

4. A powdered material according to claim 1, characterised in that said powder particles exhibit a maximal particle size less than 20 μm, preferably less than 10 μm.

5. A powdered material according to claim 1, characterised in that the cement-based system comprises cement in the group that consists of aluminates, silicates, phosphates, sulphates and combinations thereof, preferably having cations in the group that consists of Ca, Sr and Ba.

6. A powdered material according to claim 1, characterised in that the granules also comprise up to 50%, preferably 10-40% and even more preferred 20-35% of one or more additives that exhibit a refractive index in visible light that deviates 15% at the most, preferably 10% at the most and even more preferred 5% at the most from the refractive index of the hydrated binder phase.

7. A powdered material according to claim 6, characterised in that said additive consists of glass particles, preferably particles of silicate glass, said additive preferably containing an atom type with a density above 5 g/cm³, preferably heavy metals from V and upwards in the periodic system and even more preferred Ba, Sr, Zr, La, Eu, Ta and/or Zn.

8. A powdered material according to claim 6, characterised in that said additives comprise a glass phase that exhibits the capacity following saturation with a liquid reacting with the binder phase to hydrate to a chemically bonded ceramic material.

9. A powdered material according to claim 1, characterised in that said granules exist in a composition that comprises up to 50%, preferably 5-30% and even more preferred 10-20% non pre-compacted powdered material, preferably of the same cement-based system as the powdered material in the granules.

10. A powdered material according to claim 9, characterised in that the non pre-compacted powdered material exhibits a maximal particle size smaller than 20 μm, preferably smaller than 15 μm and even more preferred smaller than 10 μm.

11. A powdered material according to claim 9, characterised in that the non pre-compacted powdered material comprise up to 40%, preferably 5-30% and even more preferred 10-20% of a filler material, preferably a filler material in the form of plates, fibres or whiskers, that increases the strength and preferably exhibits a refractive index in visible light that deviates 15% at the most, preferably 10% at the most and even more preferred 5% at the most from the refractive index of the hydrated binder phase.

12. A raw compact, characterised in that it is composed of a powdered material according to claim 1 and in that it has an average degree of compaction above 55%, preferably above 60%, even more preferred above 65% and most preferred above 70%.

13. Method in connection with the manufacturing of a ceramic material from a powdered material, the binder phase of which consisting of a cement-based system that has the capacity following saturation with a liquid reacting with the binder phase to hydrate to a chemically bonded ceramic material, characterised in that said powdered material is compacted to a degree of compaction above 55%, where after it is finely divided into granules of powder particles, which granules exhibit a mean size of 30-250 μm.

14. Method according to claim 13, characterised in that the powdered material is in the form of granules of powder particles, which granules exhibit a degree of compaction above 55% and a mean size of 30-250 μm.

15. Method according to claim 13, characterised in that said granules are mixed with up to 50%, preferably 5-30% and even more preferred 10-20% non pre-compacted powdered material of the same cement-based system as the powdered material in the granules.

16. Method according to claim 13, characterized in that the material is compacted to a raw compact that exhibits an average degree of compaction above 55%, preferably above 60%, even more preferred above 65% and most preferred above 70%.

17. Method according to claim 13, characterised in that the material is suspended in a liquid that reacts with the binder phase, where after the resulting suspension/paste is drained and compacted before the material is allowed to harden by reaction between the binder phase and any liquid remaining, which compaction is preferably done to a degree of compaction above 55%, preferably above 60%, even more preferred above 65% and most preferred above 70%.

18. Method according to claim 13, characterised in that a liquid that reacts with the binder phase is distributed in said granules, where after a resulting paste is applied in a space that is to be filled with the ceramic material.

19. Method according to claim 18, characterised in that the liquid is supplied to said granules, which are thereafter pressed together by rolling, kneading or hand pressing, to a paste that is applied by packing or squirting in the space that is to be filled with the ceramic material.

20. Method according to claim 13, characterised in that said liquid that reacts with the binder phase comprises water and accelerator, dispersant and/or superplasticizer.

21. A device (10,20) for storing a powdered material and for mixing it with a liquid, characterised in that said device comprises a first chamber (1) that holds granules according to claim 1, and a second chamber (2) that holds said liquid reacting with the binder phase, and an openable seal (3,6) between the chambers (1,2).

22. A device according to claim 21, characterised in that there is a greater pressure in the second chamber (2) than in the first chamber (1).

23. A device according to claim 21, characterised in that at least the first chamber (1) has walls (4) of a wall material that allows for processing of the powdered material through the walls (4).
